(19) United States
(12) Patent Application Publication
(10) Pub. No.: US 2009/0277970 A1
(43) Pub. Date: Nov. 12, 2009

(54) CARTRIDGE HAVING SELF-ACTUATING SEAL FOR A WETTED LEAD SCREW

(75) Inventors: James J. Lind, Lenexa, KS (US); Gregory Trees, Columbus, OH (US); Joseph E. Zambanini, Delaware, OH (US)

Correspondence Address: STEVENS & SHOWALTER, L.L.P., BOX BAT, 7019 CORPORATE WAY, DAYTON, OH, 45459-4238, US

(73) Assignee: BATTELLE MEMORIAL INSTITUTE, Columbus, OH (US)

(21) Appl. No.: 12/306,278

(22) PCT Filed: Jun. 26, 2007
(86) PCT No.: PCT/US2007/014799

§ 371 Date: Dec. 23, 2008

Related U.S. Application Data
(60) Provisional application No. 60/816,549, filed on Jun. 26, 2006.

(51) Int. Cl. B05B 5/00; G01F 11/00

(52) U.S. Cl. 239/3; 239/696; 222/326

(57) ABSTRACT

A cartridge for a spraying device, as well as a spraying device incorporating the cartridge. The cartridge includes fluid reservoir a wetted lead screw and piston that upon rotation can pressurize a fluid within the reservoir. A self-actuating seal is placed between the piston and the lead screw, and extends into the reservoir such that the pressurized fluid applies a compressive force to the outer surface of the seal, causing the seal to clamp down on the lead screw. Such sealing is especially beneficial in electrohydrodyπamic spraying devices and electrostatic spraying devices.

The present invention relates generally to devices for spraying finely dispersed liquids, and more particularly to the use of a disposable cartridge that is compatible with a handheld electrohydrodynamic (EHD) and electrostatic spray devices.

Spraying using EHD technology (also referred to as electric field effect technology (EFET)) is a process where fluids or other bulk solutions are dispensed through electrically-charged nozzles. In an EHD spray nozzle, the material to be sprayed flows through a region of high electric field strength made possible by the application of a high voltage to the nozzles and associated nozzle geometry. The high voltage causes the fluid material to acquire an electric charge; the electric field present at the nozzle tips applies a pole to the fluid; the poled fluid charge induces a force that acts in opposition to the surface tension of the material. This surface charge causes the formation of at least one ligament of thin jet of material, causing comminution of the fluid into fine droplets.

By contrast, electrostatic spraying results from forcing a jet of fluid out an orifice under pressure and electrically charging the fluid that exits the nozzle under pressure. Once out of the nozzle, the droplets form a charged spray cloud which is attracted to the nearest grounded surface. Numerous electrostatic spray nozzles are known in the art, and have critical orifice sizes designed to produce electrostatically charged particles with defined size distributions.

One advantage of the EHD process is that high fluid forcing pressures are not required, thereby reducing high-velocity fluid movement and concomitant levels of noise associated with fluid dispersal. As the fluid exits the nozzle, the repelling forces of the surface charge balance against the surface tension of the material, causing the formation of a conical spray pattern (often referred to as a Taylor cone). The tip of the cone has the greatest concentration of charge and, at that point, the electrical forces overcome the surface tension, generating the thin jet of material that breaks up into charged droplets of generally uniform size.

In either of the electrostatic or EHD methods, charged droplets or particles are readily attracted to a grounded target, adhering readily to it. As portions of the target become coated with the material, the relative electrostatic potential between coated sections and uncoated sections causes subsequent application of the charged material to be preferentially attracted to an uncoated portion of the target, thereby promoting more uniform coverage. The charged nature of the droplets is further beneficial in that their like charge tends to force them to avoid agglomeration. Soon after being deposited on the target, the material loses its charge, leaving an electrically-neutral end product.

Within the cartridge art are containers in which a generally cylindrical-shaped piston is driven along the length of a complementary-shaped inner wall of the cartridge upon rotation of a lead screw. The lead screw is threaded through the piston and extends into the fluid chamber of the cartridge. Because the screw is immersed in the fluid that is contained within the cartridge, it is sometimes referred to as a “wetted” lead screw. Fluid disposed downstream of the piston is forced through an outlet or an orifice in response to the increasing pressure within the cartridge by piston movement in the downstream direction.

Unfortunately, the above-mentioned cartridge is prone to leakage, especially in regions between the outer periphery of the piston and the inner wall of the cartridge, as well as the threaded space between the screw and the piston. In an application where a cartridge of this type may be used in a device with electronics, the fluid can potentially leak into regions where electronic and other liquid-intolerant components reside. As well, when the cartridge or device is being stored during long periods of time during shipping and storage on shelves or between uses, an unacceptable quantity of fluid may be lost. This problem is particularly acute in situations where the liquid is expensive or hazardous, such as a pesticide, herbicide, flammable materials or the like. This problem is exacerbated when the cartridge is used for applications requiring higher fluid pressures, such as for higher viscosity fluids or in conjunction with the aforementioned electrostatic spraying device.

What is desired is a leak-free cartridge, and more desirably, a leak-free disposable cartridge that can be used with an EHD or electrostatic device that is inexpensive to manufacture and easy to dispose of once the contents are dispensed.

These desires are met by the present invention, wherein a cartridge, a spray device and a method of dispensing a fluid are disclosed. In accordance with a first aspect of the present invention, a cartridge that is configured to cooperate with an electrostatic-based, EHD-based or other pressure-based spray device is disclosed. The cartridge preferably includes a fluid chamber that has a proximal end (nearest the user) and a distal end in opposition to one another. A lead screw is situated within the fluid chamber, and extends substantially between the proximal and distal ends. In addition, the cartridge includes a piston defining a bore therein such that the piston is threadably cooperative with the lead screw. With this arrangement, when the lead screw turns, the piston advances toward one end of the fluid chamber to force at least a portion of a fluid disposed therein out a discharge aperture formed in the cartridge. A self-actuating seal disposed in the bore is threadably cooperative with the lead screw so that fluid leakage between the bore and the lead screw is inhibited. Moreover, the seal extends beyond the axial footprint of the piston so that the outer surface of the seal is exposed to the increased pressure of the fluid that is being pressurized by the movement of the piston. The fluid pressure in turn imparts a force to the surface of the seal, causing it to compress and tighten its fit with the lead screw. In addition, a fluid outlet is coupled to the fluid chamber such that fluid forced out of the fluid chamber by operation of the lead screw and piston will be discharged through the outlet.

Optionally, the seal has an elastomeric sleeve disposed on its outer surface. In one configuration, the seal is integrally formed with the piston.

The outer surface of the seal may be tapered from a first outer diameter at a more proximal end to a second outer diameter at a more distal end. This gives the seal a frustro-conical shape with the second outer diameter being smaller than the first outer diameter. The threadably cooperative portions of the lead screw and the seal may comprise complementary-shaped threads formed in each. The seal and the piston may be integrally formed as a one-piece device, or may be separately formed as multiple pieces that can cooperate together. In this latter configuration, they are rigidly affixed to one another such that neither substantially rotate in response to the rotation of the lead screw.

In a particular form of the cartridge, the seal that is situated between the screw and the piston is preferably made up of material having the substantially the same or higher durometer as the material of either the lead screw or the piston, and may be molded with the piston as a single component. Seal materials may include, for example, silicone, rubber, urethane, and like flexible polymers that are compatible for use with a fluid to be dispensed from the cartridge and have the necessary properties to seal against the wetted lead screw in accordance with the present invention. In particular, the seal includes a sleeve which extends into the fluid chamber and which is designed to be self-actuating to provide additional sealing pressure to prevent leakage at the wetted lead screw as pressure in the fluid chamber increases.

The cartridge may further comprise a frame configured to provide axial and radial support to the lead screw. More particularly, the frame is connected to the fluid chamber such that the frame inhibits movement of the lead screw toward one end (for example, the proximal end) of the cartridge. Another function of the frame is to support and center the screw as the piston advances. In one configuration, the frame is made up of a central hub from which numerous radially-extending spokes contact the inner wall of the fluid chamber.

According to another aspect of the invention, a spray device is disclosed which includes a fluid dispensing cartridge. The cartridge includes a fluid chamber with proximal and distal ends substantially opposite one another, a lead screw disposed within the fluid chamber, a piston cooperative with the lead screw so that when the lead screw rotates, the piston advances toward the distal end to pressurize a fluid contained in the cartridge, and a self-actuating seal disposed between a bore formed in the piston and the lead screw. The self-actuating nature of the seal is such that it is responsive to environmental changes (specifically, changes in pressure in the fluid chamber) to inhibit fluid leakage that would otherwise be prevalent under such environmental changes. In particular, the seal achieves at least some of its self-actuating capability by its distal extension into the fluid chamber. Pressure applied to an outer surface of the distal extension from the pressurized fluid causes the seal to compress, thereby increasing tightness of fit between the seal and the screw. The device additionally includes one or more discharge nozzles in fluid communication with the fluid chamber, as well as a handle configured to attachably receive the cartridge. The handle includes a power source that, through cooperation with the lead screw, pressurizes the fluid disposed in the fluid chamber so that at least a portion of the fluid is discharged. The handle also includes a high voltage electrical source configured to impart an electric charge to one or both of the fluid and the discharge nozzle(s), and a switch to selectively turn the spray device on and off. In configurations where multiple nozzles are used, the manifold is preferably designed to maintain substantially equal flow to each nozzle; however, the cartridge of the present invention does not depend on such flow being substantially equal, and may be used with other nozzle configurations. The handle preferably includes the power supply (preferably batteries, disposable or rechargeable), motor, drive mechanism for the lead screw, high voltage converter, and controller components. In alternative configurations where the cartridge is not detachable from the handle, the handle may include any combination of the power supply, fluid reservoir, pump, or controller/processor.

The cartridge can be equipped with one of various forms of discharge closure means, examples of which include a septum or a stop-cock valve (the latter formed in an end cap) and operable to either establish fluid flow or seal the cartridge, either of which are placed at the distal end of the fluid chamber to prevent leakage or spillage of the liquid when the device is not in use. In a particular form, the spray device is an EHD spray device. As previously mentioned, a spray manifold and numerous nozzles in fluid communication with the spray manifold can be used, where one or both of the manifold and the nozzles are electrically coupled with the high voltage electrical source so that the fluid being discharged from the nozzles is comminuted. The spray device may also be configured an electrostatic spray device, where higher pressure fluid environments may involve the use of handle or cartridge components that are compatible with such higher pressures. Regardless of whether the spray device is an EHD or electrostatic device, it may also include a closure valve fluidly disposed between the fluid chamber and the one or more discharge nozzles.

In a preferred (although not necessary) embodiment, the cartridge is filled only once and is non-reusable or disposable. Although the nature of what is disposable in a pedestrian sense is almost limitless, it will be appreciated that in the present context, non-reuseable fluid containing and dispensing components such as the cartridge are distinguished over their reuseable counterparts when it is more practical (for example, from a cost, contamination, cleanliness or hygenic perspective) to dispose of the fluid container once the fluid has been expended rather than refilling and resealing the container. Evidence of non-reuseability of the cartridge includes having the fluid hermetically sealed inside the cartridge such that prior to the cartridge being coupled to the handle, the fluid inside is substantially isolated from the ambient environment. Upon receipt of the cartridge into the handle, a permanent aperture is formed in the cartridge (such as by a needle on the handle puncturing a septum in the end of the cartridge). In a non-reuseable cartridge, replacement of coverage of the aperture is impractical or otherwise not-cost effective relative to the cost of providing a new cartridge. The present disposable features can be extended to other parts such that an assembly of such parts is disposable. For example, the cartridge of the spray device can be rigidly affixed to at least one of the spray manifold and the nozzles such that once the fluid contained in the fluid chamber is dispensed, the cartridge, the spray manifold and the nozzles form a disposable assembly.

According to still another aspect of the invention, a method of spraying a fluid is disclosed. The method includes disposing a fluid within a cartridge, providing power to the cartridge through a handle so that a lead screw advances a piston to pressurize the fluid and force it out of the cartridge, and inhibiting fluid leakage between a self-actuating seal and the piston by having the seal distally extend into the fluid chamber from the piston such that the pressurized fluid applies pressure to an outer surface of the seal. In this way, the application of pressure from the fluid compresses the seal an amount necessary to increase the tightness of a fit between the seal and the screw.

Optionally, the seal and the piston are integrally formed as a unitary (i.e., one-piece) structure. In another option, the seal is made up of a material that is at least as hard as a material making up the piston. The seal may additionally have an elastomeric sleeve placed on it. The spray device may be an electrostatic or EHD spray device; in the case of the latter, the handle further comprises: a rotational power source and a high voltage electrical power source, a power switch, a spray manifold and numerous nozzles in fluid communication with the spray manifold. At least one of the manifold and the nozzles are electrically coupled with the high voltage electrical power source such that upon application of a voltage, at least a portion of the fluid being discharged from the plurality of nozzles is comminuted during the method.

The following detailed description of the present invention can be best understood when read in conjunction with the following drawings, where like structure is indicated with like reference numerals and in which:

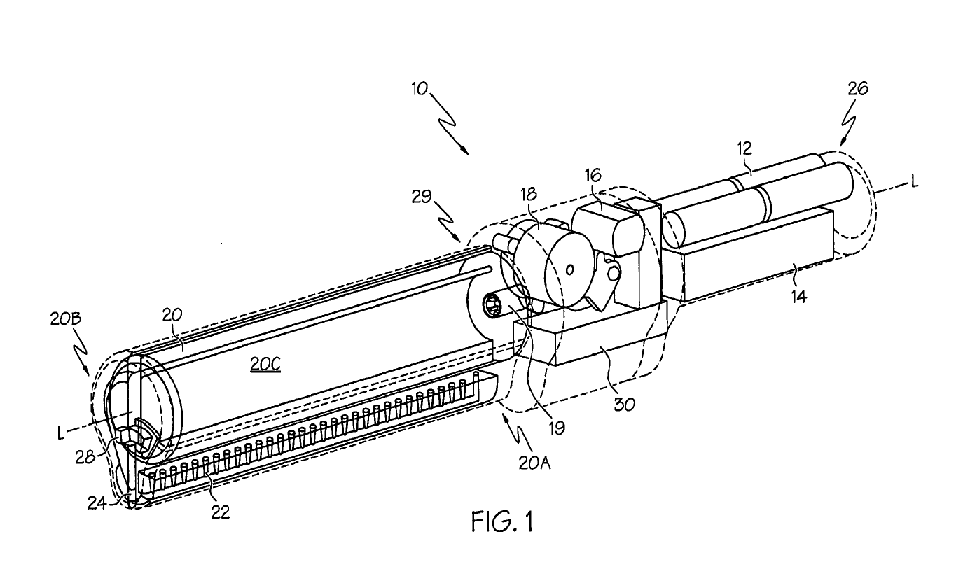

FIG. 1 shows a cartridge according to an aspect of the present invention, and connection of the cartridge to an EHD spray device;

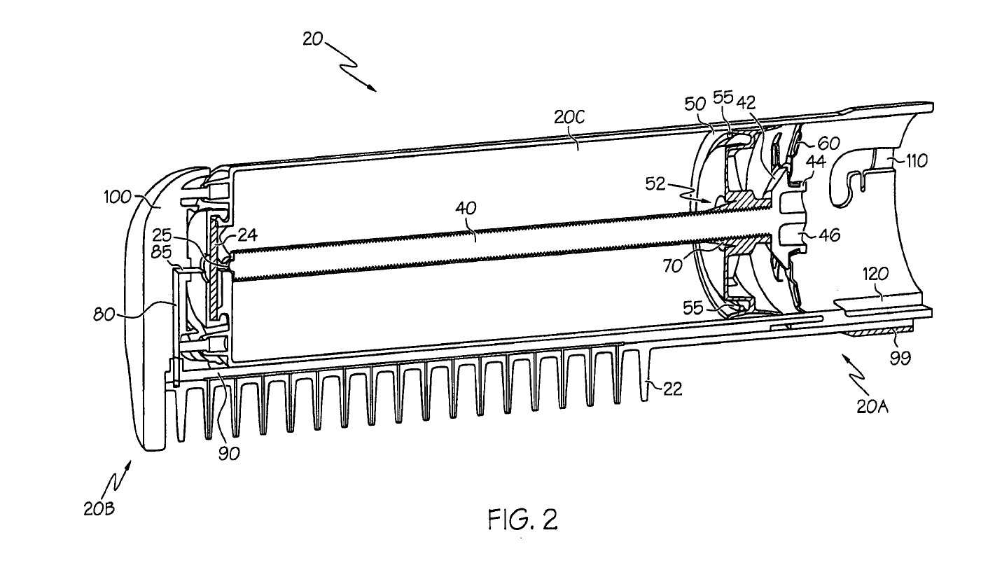

FIG. 2 shows a perspective cutaway view of the cartridge of FIG. 1 with a cap placed adjacent a distal end of the cartridge;

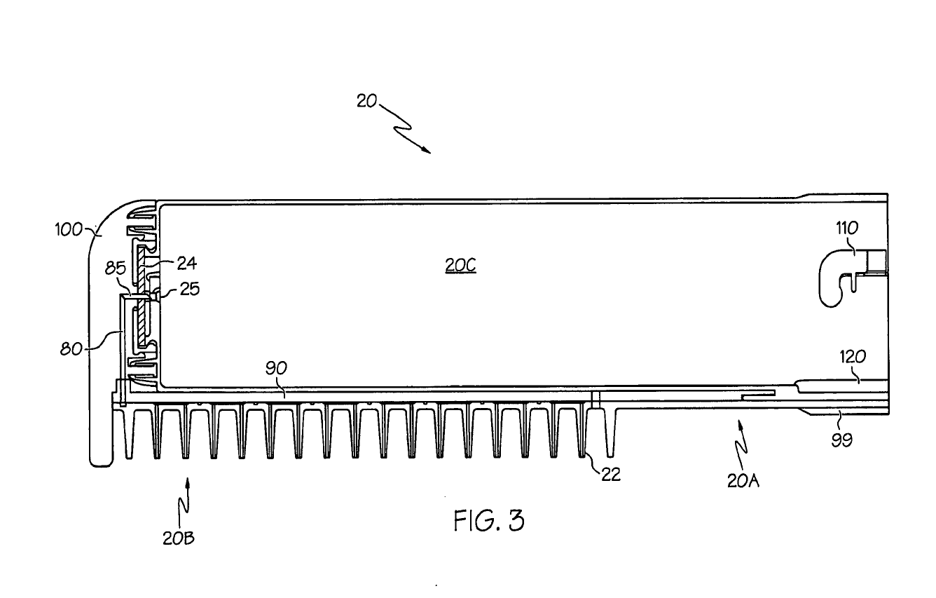

FIG. 3 shows a side cutaway view of the cartridge of FIG. 1 with the wetted lead screw, piston, seal and frame removed;

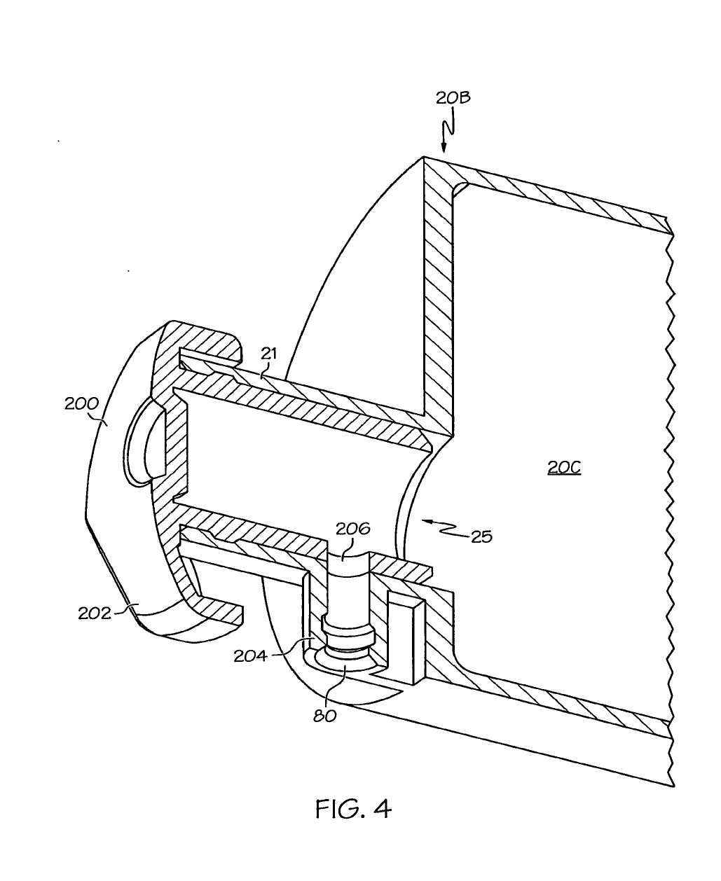

FIG. 4 shows the use of a stop-cock valve as an alternate embodiment for selective closure of the cartridge;

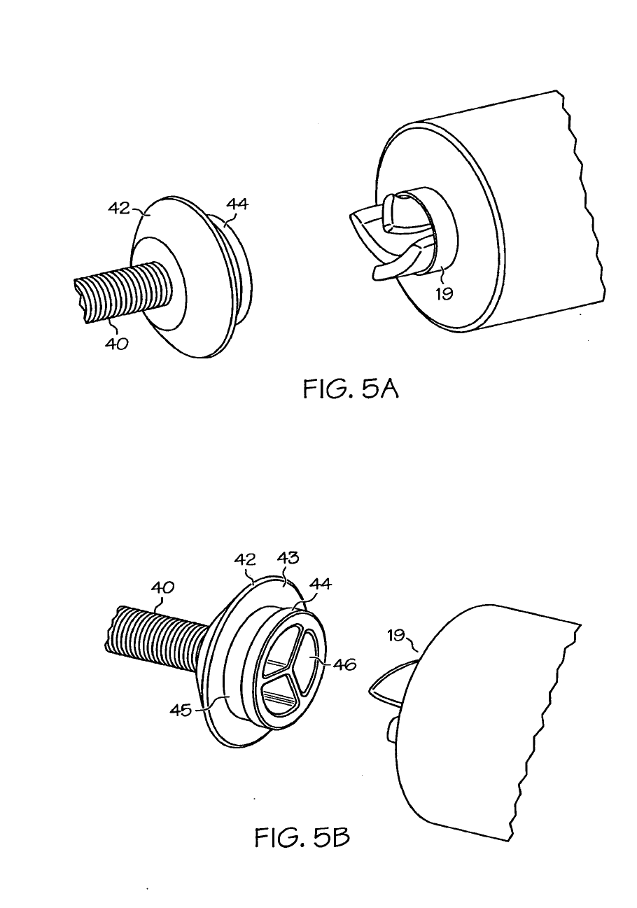

FIG. 5A shows a first perspective view of a connection of the wetted lead screw to the driver of a sprayer handle;

FIG. 5B shows a second perspective view of a connection of the wetted lead screw to the driver of a sprayer handle;

FIG. 5C shows a perspective view of the preferred embodiment of a hub for the wetted lead screw;

FIG. 5D shows a perspective view of the preferred embodiment of the driver that could be coupled to the hub of FIG. 5C;

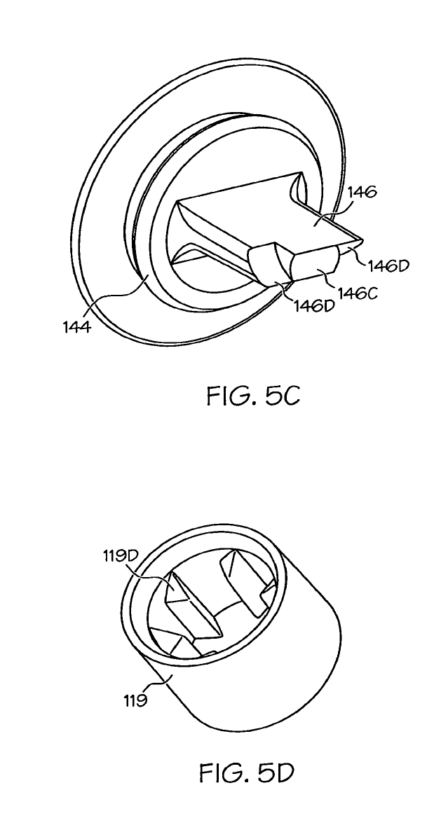

FIG. 6 shows the frame that is used to support the wetted lead screw in the cartridge;

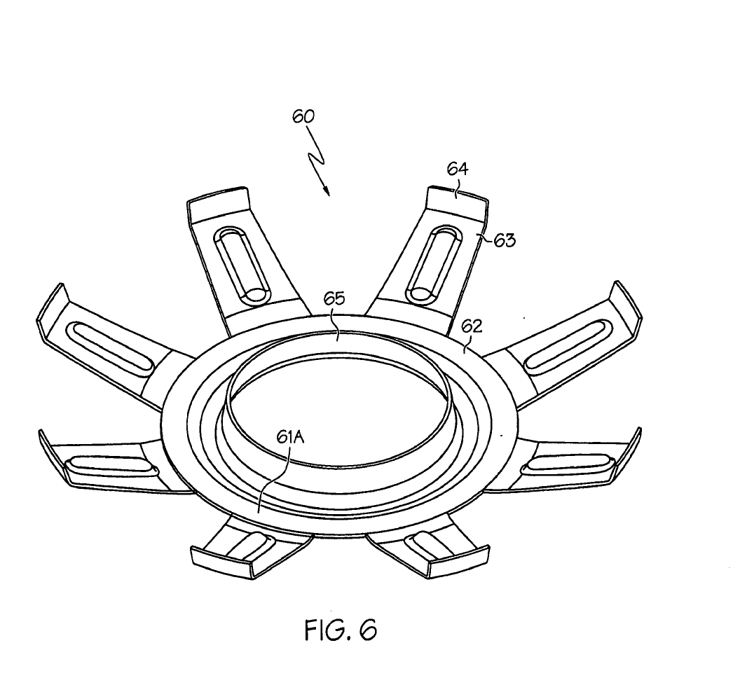

FIG. 7A shows a perspective view of the piston and seal of FIG. 2;

FIG. 7B shows a reversed side cutaway view of the piston and seal of FIG. 7A, presently shown without a retaining ring;

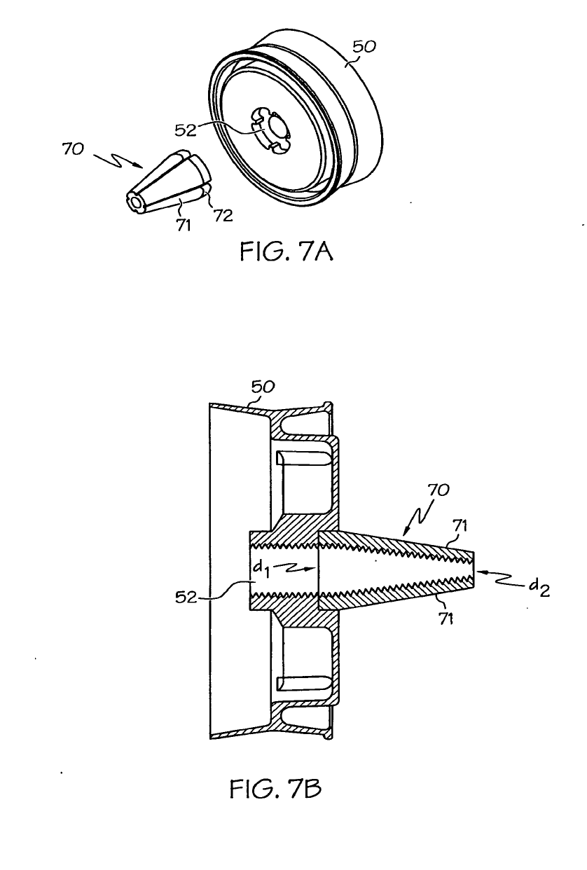

FIGS. 8A through 8C show various embodiments of the engagement of the seal of the present invention with the wetted lead screw;

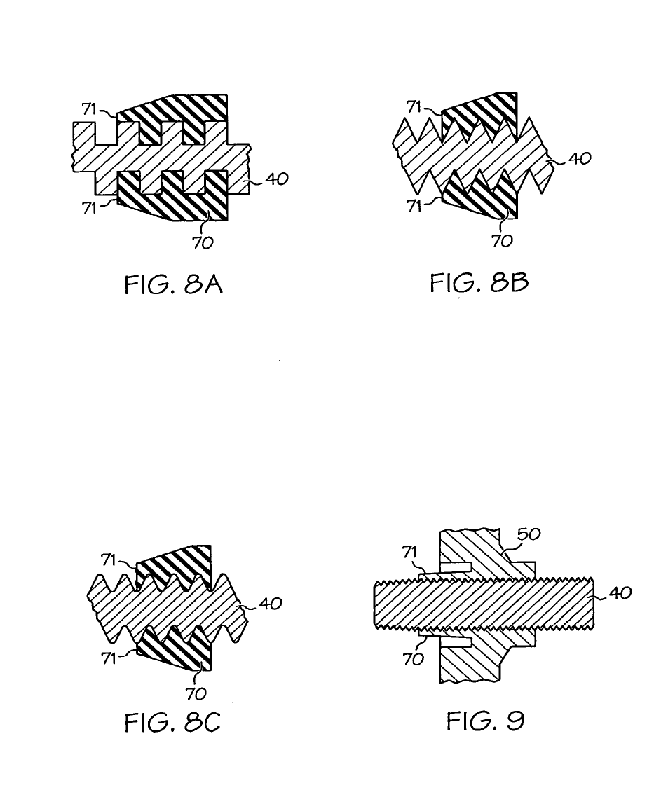

FIG. 9 shows an alternate embodiment of the seal of the present invention;

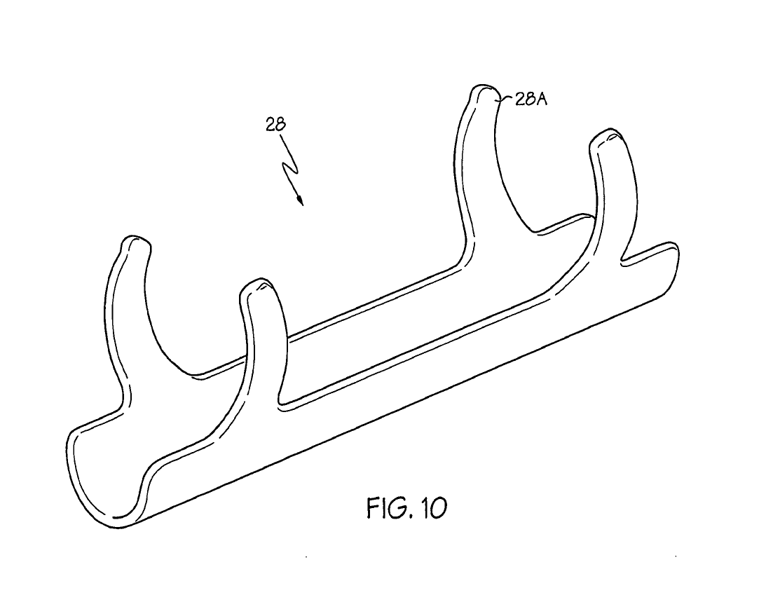

FIG. 10 shows a nozzle cover that can be resiliently snapped onto the cartridge of FIG. 2;

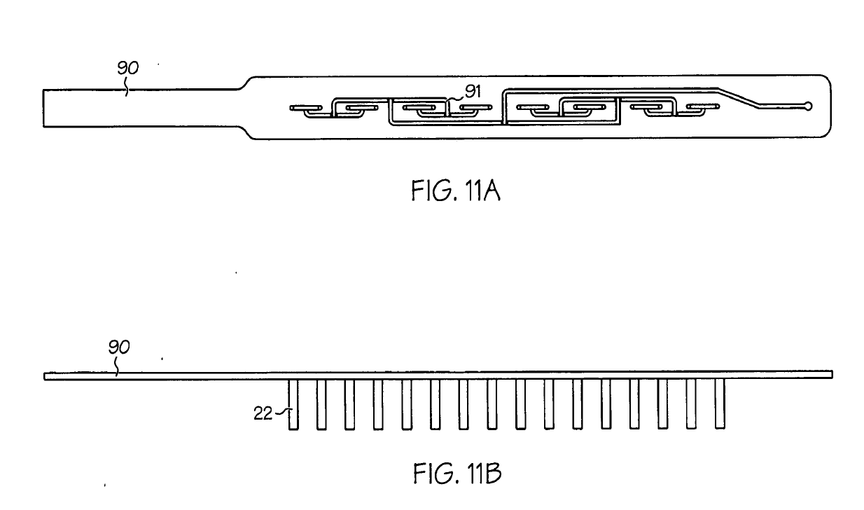

FIGS. 11A and 11B show top and elevation views, respectively, of the manifold;

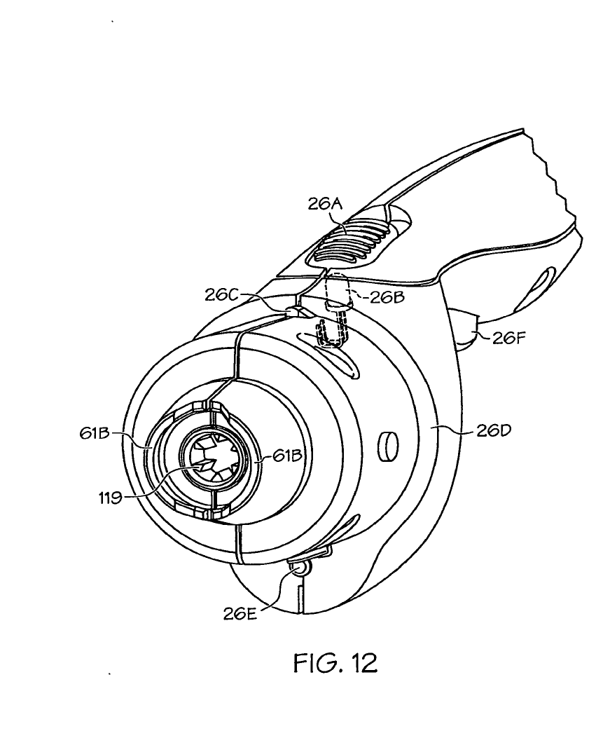

FIG. 12 shows a view of an alternate embodiment of a handle used to connect to a cartridge;

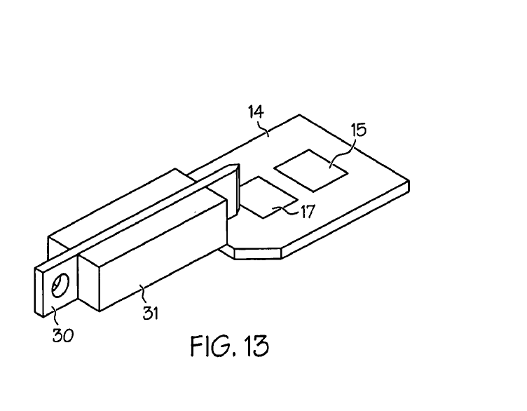

FIG. 13 shows a converter that can be situated within the handle of FIG. 1 or 12;

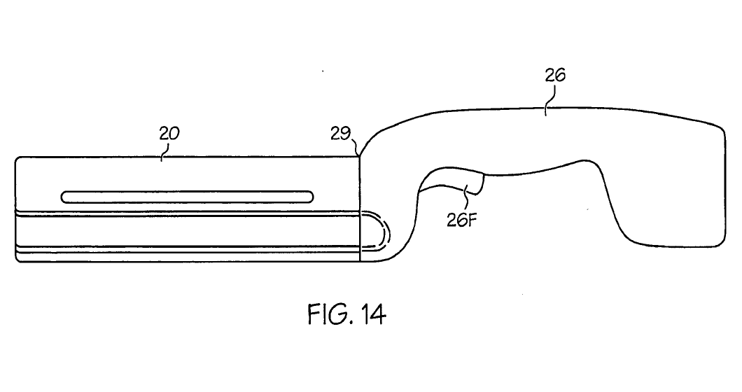

FIG. 14 shows a side elevation view of the handle of FIG. 12 connecting to a notional cartridge;

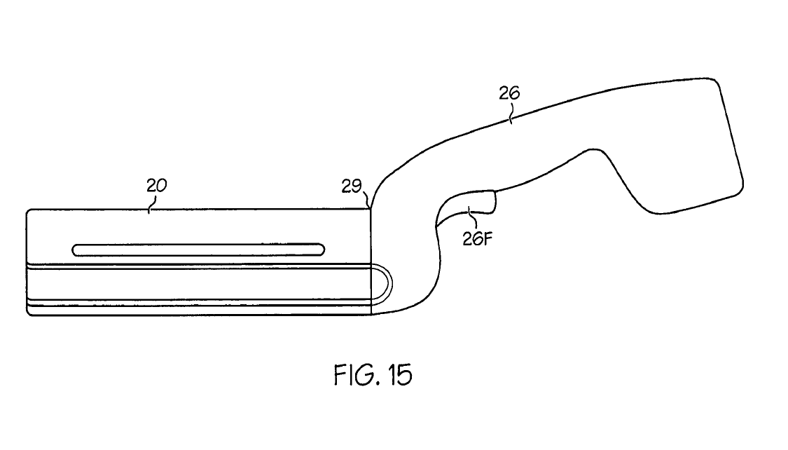

FIG. 15 shows an alternate embodiment of the handle, now angled relative to the cartridge to which it is connected;

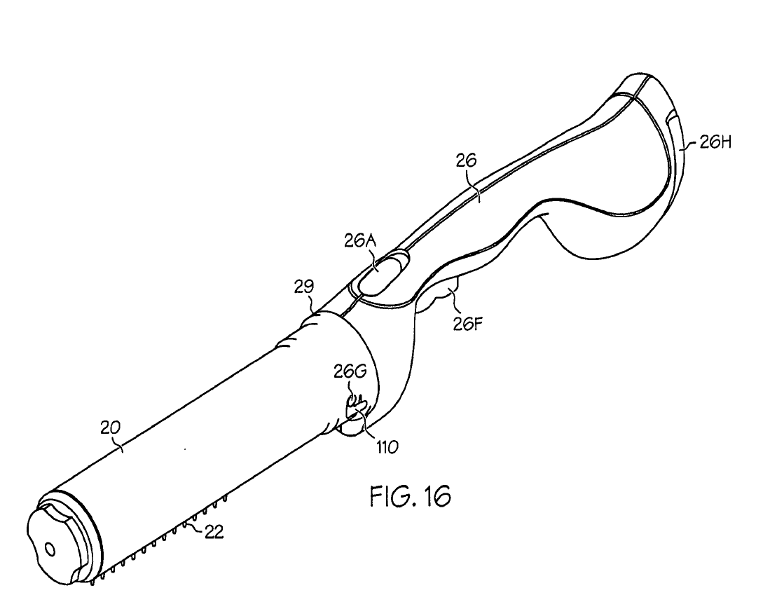

FIG. 16 shows a perspective view of the attachment of yet another handle embodiment to a cartridge; and

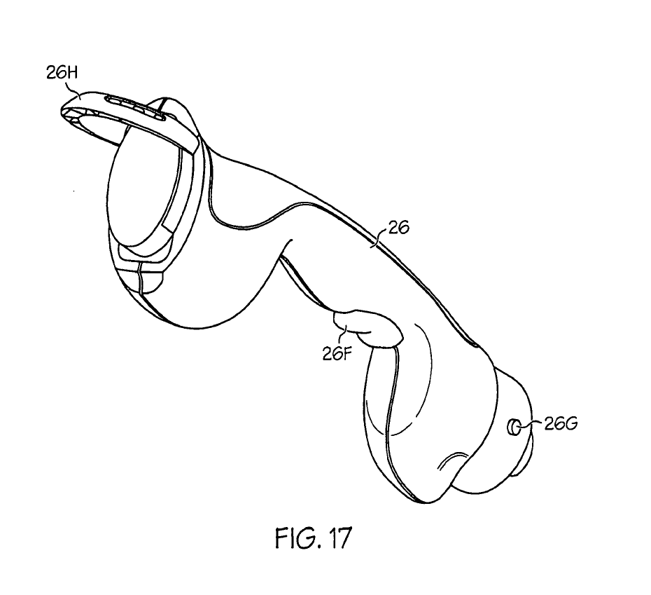

FIG. 17 shows a rear perspective view of the handle of FIG. 16, with a ring with which to hang the handle is deployed.

Referring first to FIGS. 1 and 14 through 16, an exemplary EHD sprayer 10 which may be used in accordance with the present invention is shown with a handle 26, a cartridge interface 29 and fluid-containing cartridge 20. In a preferred form, cartridge 20 is preferably disposable and not reusable. An array of nozzles 22 are situated beneath cartridge 20, and are in fluid communication therewith to dispense a fluid. Details of the configuration of the array of nozzles 22 are discussed in PCT Application US2004/000556 entitled SPRAY HEAD FOR AN ELECTROHYDRODYNAMIC SPRAY DEVICE AND ELECTROHYDRODYNAMIC SPRAYER SYSTEM, which published on Jul. 29, 2004 as WO 2004062812, is assigned to the Assignee of the present invention and is herein incorporated by reference. The nozzles 22, as well as a manifold 90 (discussed in more detail below) can be made of a conductive plastic material, using as base materials polymers, for example polycarbonate, high density polypropylene, or preferably polypropylene, acrylonitrile-butadiene-styrene (ABS) and high density polyethylene (HDPE), which can be appropriately compounded as known in the art to exhibit conductive properties. Preferably, such materials exhibit surface resistivity from approximately 10² to 10¹⁴ ohm/square, and volume resistivity of 10² to 10¹⁴ ohm/cm. Alternatively, the nozzles 22 may be made of other electrically conductive (for example, metallic) materials or combinations of electrically conductive and non-conductive materials that can be cast or otherwise formed into the appropriate geometry. The nozzles 22 are preferably electrically connected to a high voltage source (discussed below) within the sprayer 10. In either way, the EHD sprayer 10 can impart the necessary charge to the droplets of liquid that are discharged from the nozzles 22.

The handle 26 is used to house a power supply 12, a converter (also referred to as an electronics or circuit board) 14, a motor 16, a drive mechanism 18 and driver 19, and a high voltage multiplier 30. The power supply 12 may comprise a portable, on-board voltage supply, such as through a set of batteries, for example four AA batteries, which may or may not be rechargeable. As shown with particularity in FIG. 13, converter 14 includes a processor 15, transformer 17 and potting material 31, the last to encase the multiplier 30 to provide insulation for the high voltage emanating therefrom. The converter 14 steps up the power supply 12 voltage, in effect to convert the voltage from the power supply 12 to a higher level in order that it may (among other things) power the multiplier 30. The multiplier 30, in turn, converts the voltage from the converter 14 to a level suitable for comminuting a liquid contained within the cartridge 20 with EHD forces. The multiplier 30 may be configured as a fly back oscillator circuit as understood by those skilled in the art. In an exemplary form, converter 14 (with transformer 17 and multiplier 30) can take an input voltage of between four and six DC volts and convert that to between twenty thousand and thirty thousand DC volts. An electrical connection (not shown) between the multiplier 30 and the nozzles 22 enables a necessary charge to be formed on the latter such that when fluid passes therethrough, it is comminuted when the sprayer is used for EHD spraying.

As mentioned above, the cartridge 20 may also be made compatible with spraying devices that require higher fluid pressures, such as electrostatic spraying devices. In such circumstances, the spraying device 10 described herein for use in EHD spraying could, with appropriate modifications, be used as an electrostatic or related high pressure spraying device. Although a number of components of the sprayer may be similar, the operating requirements for production of a Taylor cone necessary for EHD spraying versus a jet necessary for electrospraying may dictate changes in certain componentry. In particular, an electrostatic spraying device would include a larger motor 16 to generate higher pressures, corresponding strength in the fluid chamber and piston 50, as well as the need for smaller apertures 25, and fluid channels, manifolds and nozzles having orifices properly sized for the kind of operation that leads to electrostatic spraying. While use of the cartridge 20 is especially beneficial in EHD spraying and that at least one preferred embodiment of the present invention be configured for EHD spraying, the present inventors believe that its use in electrostatic and other high pressure-based spraying is warranted. Thus, even though the particle size and control over the particle size that is achievable with EHD spraying is sacrificed in higher pressure electrospraying applications, where a charged jet rather than a Taylor cone is produced at the nozzles, other desired characteristics of spraying charged particles are still preserved using the cartridge of the present invention, particularly in such higher pressure electrospraying configurations. The present inventors have also recognized that the presently-shown EHD spraying device 10 may require similar increases in motor or piston robustness in circumstances where the fluid being dispensed has a high viscosity. Referring to FIGS. 2 and 3, cutaway views showing the cartridge with (FIG. 2) and without (FIG. 3) internal componentry is shown. The cartridge 20 and the cartridge interface 29 are adapted to enable the cartridge 20 to attach and detach quickly, easily, and without spillage of contained liquid. The inside (fluid-containing) portion of cartridge 20 is bounded at its proximal and distal ends 20A, 20B by a piston 50 and in one configuration, by a septum 24, and radially by the inner wall 20C such that a fluid chamber or reservoir is defined. Septum 24 forms a closure barrier at the distal end 20B of cartridge 20, and can be punctured by a needle 85 formed into discharge tube 80 that makes up a part of cap 100. Needle 85 may be configured as a syringe needle, while septum 24 is made from a material (such as rubber) that substantially self-seals. To promote the piercing of septum 24 by needle 85, cap 100 needs to be snapped fully in place. As will be noted, the cap 100 in FIG. 2 is not snapped fully in place, such that needle 85 has not poked a hole in septum 24, whereas in FIG. 3, cap 100 is shown snapped fully in place such that needle 85 pierces septum 24 to produce the aperture 25 that enables the flow of liquid from the fluid chamber to the header 90.

In an alternative configuration shown in FIG. 4, a valve device, such as a stop-cock 200, is shown at the end opposite the piston as a means of sealing off flow from the fluid chamber. Unlike the configuration depicted in FIGS. 2 and 3, which included septum 24 being pierced by needle 85 to produce an aperture 25 in the distal end 20B of cartridge 20, the present embodiment utilizes a rotating handle 202 that selectively engages valve 206. The stationary part 204 of stop-cock 200 remains fixed to a complementary neck 21 on cartridge 20 by integral formation (as shown), snap-fit, threaded or related connection, and acts as a housing through which discharge tube 80 passes.

Referring again to FIGS. 2 and 3, fluid that is forced out of cartridge 20 passes through discharge tube 80 and into manifold 90, where a series of channels (shown and described in more detail below) distribute the fluid to the nozzles 22. In operation, high voltage from handle 26 is imparted to at least one of the manifold 90 and nozzles 22 so that an adjacent charge field to act upon the fluid. An electrical connection 99 is used to establish electrical continuity between the power source 12 and associated voltage multiplying components situated on converter 14.

Piston 50 is mounted onto a wetted lead screw 40. Threads on both cooperate with each other such that upon rotation of screw 40, piston 50 progresses from the proximal end 20A to the distal end 20B. While the direction of travel of the piston 50 towards the distal end 20B as described above is preferred, it is not intended to limit the scope of the invention described herein. As such, it will be appreciated by those skilled in the art that the cartridge 20 may be designed so that the wetted lead screw 40 drives the piston 50 from the distal end 20B towards the proximal end 20A of the fluid chamber. A relatively snug fit between the outer periphery of the piston 50 and the inner wall 20C prevents the piston 50 from sympathetically turning with the lead screw 40. It will be understood by those skilled in the art that other anti-rotation features may be employed, such as an axial key and slot arrangement formed in the piston and cartridge inner wall, or alternatively, an oval piston. While it is preferable that the piston not rotate in relation to the inner wall 20C, in some applications the piston may rotate slightly in relation to the bore wall, but at a rate slower than the lead screw. Retaining ring 55 may be disposed substantially about the periphery of piston 50 to promote rigidity and shape retention. Cartridge 20 may optionally include a window (not shown) or be made of a transparent or translucent material to provide a visual dose cue to indicate the volume of fluid or number of doses remaining. Other indicia, such as an auditory application cue (not shown) through timed sounds linked to volume dispensing rate could also be used.

Referring next to FIGS. 7A through 9, in conjunction with FIG. 2, a seal 70 is situated between an axial bore 52 formed in the piston 50 and the threads of screw 40. As with the piston 50, seal 70 may include threads on its inner bore (shown with particularity in FIGS. 8A through 8C) so that the seal 70 can cooperate with the rotational movement of screw 40. The seal 70 is self-actuating in that in response to a pressure buildup in the fluid (which is due to the movement of the piston 50 moving toward the distal end 20B of the fluid chamber), the seal 70 compresses in response to the increased fluid pressure on its outer surface such that it clamps down on lead screw 40, which has the effect of reducing or eliminating any residual gaps between the seal 70 and lead screw 40. In this regard, the seal 70 is distinguished over seals that do not present a significant surface area with which the compressive action of the pressurized fluid can operate. Thus, for example, seals that do not extend beyond the footprint of the piston to which they are attached would have a difficult or impossible time compressing in response to an increased pressure fluid, and would accordingly not be considered to be self-actuating. Although the seal 70 shown with particularity in FIGS. 7A and 7B has a tapered outer shape, the inventors have also discovered that a generally cylindrical-shaped seal (not shown) may also be employed.

In order to maximize its sealing feature, seal 70 is preferably made from a material a durometer the same as or greater than that of the screw 40 or piston 50, and is more preferably formed as a one-piece element with the piston 50. This latter one-piece configuration is particularly well-suited to a self-actuating structure, as the application of pressure from the fluid in the fluid chamber puts added pressure on the outer surfaces of the sleeve 71 of seal 70, increasing the sealing pressure between the seal 70 and the threads of the screw 40. Such is advantageous in that it reduces the possibility of backwards leakage along the screw 40. As shown with particularity in FIG. 7A, a retaining ring (also referred to as an insert) 72 can be placed in bore 52 ahead of seal 70. Retaining ring 72 may have a shape complementary to that of bore 52, where for example, both are shown with a clover-shaped cross-section.

Referring with particularity to FIGS. 2 and 9, an embodiment of the seal 70 is shown where it is integrally formed as part of piston 50 such that together they define a one-piece structure. As with the previous multi-piece configuration shown in FIGS. 7A and 7B, the present one-piece design can be formed from a single material, or be made from two separate materials that are co-formed. Examples of seal material, if formed as a separate element in the piston, can be a silicone-based or plastic-based structure. In a preferred form, (whether integrally manufactured into piston 50 as a single element or as part of a multi-piece assembly), the material of seal 70 may be of a harder material than that of the piston 50. Of course, both the seal 70 and piston 50 could be made of the same material in a one-piece form to ensure a leak-free connection.

For best sealing properties, the seal 70 is manufactured or molded to match the thread design of the wetted lead screw 40. As shown illustratively in FIGS. 8A through 8C, by way of example and not limitation, these may be cut threads, rolled threads, squared threads or other thread designs. Rolled threads are preferred for ease of manufacture of the seal 70 which is made so that the seal 70 is threaded to match the lead screw 40 thread design. With particular reference again to FIGS. 7A and 7B, this structure may be produced by separately manufacturing or molding the seal 70 for insertion into piston 50, or by molding the seal 70 in place in the cavity of the piston 50, which is preferred for the two piece structure shown.

The seal 70 of the present invention may include an additional sleeve 71 to help the seal 70 compresses more tightly against the lead screw 40 to increase sealing pressure against leakage. Seal 70, by virtue of being made from a material that is the same or softer than that of lead screw 40, assumes a shape that closely conforms to the screw's threads. Such conformal fit promotes a sealing action at the thread interface. The inclusion of sleeve 71 introduces additional compression forces such that the seal 70 would experience an increased force at the interface of the threads to enhance the sealing action. The sealing pressure of the sleeve 71 is preferably enhanced by producing the sleeve with a slight inward taper, provided the taper is not sufficient to block the travel of the wetted lead screw 40. As seen best in FIG. 7B, the seal 70 with sleeve 71 may be tapered from a first diameter d1 at the piston to a second diameter d2 in the fluid chamber. Such could ease the mating of the screw 40 to the seal 70. In such configuration, passage of the screw 40 into or beyond the distal end of the seal 70 could force that end to deform, thereby forming a tighter fit between them. In another form (not shown), the inner diameter is not tapered along the path of the seal 70 so that the dimension of the passageway formed in the seal 70 is substantially similar to that of the screw 40. The length, internal taper, wall thickness profile, and flexibility of the material 71 will control the sealing pressure initially applied by the seal material as it is stretched over the wetted lead screw 40, and its length, profile and flexibility will control the effect of external pressure in providing additional sealing pressure. The seal 70 may further be designed so that when the lead screw 40 is inserted into the piston 50, the tapered portion of the sleeve 71 expands such that the sealing force is high just in the tapered portion to minimize frictional losses. The sleeve design is preferably incorporated into the piston 50 as a one-piece molded element, but may be formed of a different material in place in the piston or added as an insert. While the sleeve will cause added friction, which draws more power and tends to add cost to the cartridge and sprayer by requiring stronger parts, and a larger motor, in certain applications, particularly higher pressure applications, its sealing properties can provide a performance advantage in applications where the fluid chamber is pressurized.

The seal designs of FIGS. 8A through 8C show self-actuating sleeve 71 formed as a projecting portion of seal 70, engaged with the wetted lead screw 40. As may be seen in comparison with the internal taper from d1 to d2 in FIG. 7B, the internal diameter of the seal 70 is stretched to fit over the wetted lead screw 40 in FIGS. 8A through 8C.

Referring again to FIG. 2, and further in conjunction with FIGS. 5A through 5D and 6, screw 40 extends from one end of the fluid chamber to the other. Referring with particularity to FIGS. 2, 5A and 5B, a proximal end of screw 40 fans out to define a hub 42, while at its distal end, screw 40 preferably has a ball end supported in a socket. Connectors to the ball and socket arrangement, such as conical and other like connectors known in the art may be used. Alternatively, the screw 40 may be cantilevered, supported at the one end and by the piston 50 and frame 60, but not at the distal end. To keep screw 40 radially centered in the fluid chamber and aligned with the driver 19, hub 42 is mounted to a frame 60. Referring with particularity to FIG. 6 in conjunction with FIG. 2, frame 60 assumes a spider-like (i.e., hub-and-spoke) shape with a ring 62 defining a central race 65, and a plurality of radially-extending legs 63 that terminate in feet 64. In this way, ring 62 acts as a hub, while the individual legs 63 act as spokes that connect the hub to the inner wall 20C of the fluid chamber. The central race 65 of frame 60 is configured to rest upon the corresponding race 45 formed in hub 42 (discussed in more detail below). Their cooperative nature allows them to act as a bearing such that screw 40 can rotate relative to the frame 60. Preferably, the frame 60 is made from a relatively rigid material, such as metal. The legs 63 are axially canted, while the feet 64 are additionally canted; this gives the frame 60 spring-like qualities to promote insertability into the fluid chamber of cartridge 20. By having the legs 63 and feet 64 be backwardly-biased, the frame 60 inhibits backward movement of the screw 40, as any attempt to push the frame 60 rearward (toward the proximal end) will cause feet 64 to splay radially outward, thereby digging into the relatively soft inner wall 20 and inhibiting additional movement.

Various rotational couplings between the driver 19 and wetted lead screw 40 are shown. Drive mechanism 18 (shown in FIG. 1) and driver 19 form a coupling at the end of a shaft on motor 16, and can rotate about the generally elongate axis L of the sprayer 10. Referring with particularity to FIGS. 5A and 5B, hub 42 includes an anterior surface 43, posterior ridge 44 and race 45. The end of hub 42 forms a multicompartmented female portion 46 that engages the male projection of driver 19. The structure of hub 42, with its race 45 that is of a smaller radial dimension than the axially adjacent anterior surface 43 and posterior ridge 44, is such that the central race 65 of frame 60 (shown in FIG. 6) can be made to fit onto the race 45 of hub 42 by snap-fit or similar connection. The drive mechanism 18 and driver 19 convey rotational motion from the motor 16 to the lead screw 40, and as may be appreciated by those skilled in the art, can also include various gearing and belt arrangements, as well as a linear drive motor arrangements to impart the necessary rotational motion. Referring with particularity to FIGS. 5C and 5D, an alternate embodiment of hub 142 includes an anterior surface 143, posterior ridge 144 and race 145. Unlike the hub 42 of FIG. 5A, hub 142 includes a male projection 146 having angled or angled arcuate surfaces 146D (in addition to generally square surfaces 146C). A complementary female driver 119 has teeth whose top surfaces 119D are also angled or angled arcuate surfaces. When male projection 146 is inserted into female driver 119 so that the surfaces 146D and 119D contact, these surfaces deflect to cause the cartridge to automatically adjust by slight rotation, typically no more than approximately fifteen degrees, for proper connection. This provides a self-adjusting feature for the handle 26 and cartridge 20.

In one form, a bayonet-type attachment 110 may be employed, as well as a keyed slot 120 to ensure proper alignment between the cartridge 20 and the handle 26 of sprayer 10. Such an attachment ensures quick connection and removal. The bayonet-type attachment 110 may be disposed on both sides of cartridge 20, so long as both can be engaged or disengaged simultaneously by relative rotation in one direction or the other between the cartridge 20 and handle 26. An example of such connection can be seen in FIGS. 2, 3, 16 and 17. Alternatively, a twist-type attachment (not shown) with a positive or friction lock, a spring mounted pin and hole arrangement (not shown), or other means for positively connecting the cartridge to the handle would be suitable. A further feature of the mechanical interface is that the mounting surface 61B (FIG. 12) is a load bearing surface which transfers the operational forces acting upon the lead screw 40 of the cartridge 20 to the handle 26 when it is assembled to the handle 26. Mounting surface 61B contacts surface 61A of the frame 60 (as shown in FIG. 6) to this end to minimize the load applied to the drive mechanism 18 and driver 19 and related internal components in the handle. The cartridge 20 and handle 26 are preferably detachable, so that cartridge 20 may be disposable (or refillable), or so that one cartridge may be exchanged for another having a different fluid. The handle interface 29 thus includes both mechanical and electrical interfaces.

Referring next to FIG. 12, in one form, the handle 26 can be ergonomically designed to minimize leverage on the hand, wrist, and/or forearm of a user. An on/off switch 26A is used to provide power to the cartridge 20. When switch 26A is in the “on” position, a light-emitting diode 26B lights up to indicate operational status. The switch 26A may control, singly or in combination, activation of indicators (such as light-emitting diode 26B), the motor 16, and the multiplier 30. An activation switch 26C is placed just ahead of seating surface 26D such that unless activation switch 26C is depressed (such as by the presence of a cartridge 20 placed against the seating surface 26D at the location designated as interface 29), connection between the high voltage coming from the multiplier 30 to contact 26E (which electrically connects to connector 99 of manifold 90) is not made, thereby preventing open exposure of a “hot” lead from the handle 26. Trigger 26F is to give the user control over the supply of electricity to the motor 16. In an alternate form, activation may be provided by trigger 26F on the grip, instead of by the on/off switch 26A. In even another form, the grip itself, minus the trigger, could be used to activate the sprayer 10.

Additional ergonomic features of the handle are shown in FIGS. 14 through 17. The internal components are placed, along with weights as needed, to effect such a balance. In a preferred embodiment, the handle 26 is weighted with the power supply 12, converter 14, motor 16, drive mechanism 18 (all as shown in FIG. 1) and, optionally, weights (not shown), so that when the handle 26 is attached to the cartridge 20, the center of balance of the spraying device thus formed is preferably located in the grip. Alternatively, the center of balance may move from outside the grip into the grip, or from inside the grip to outside the grip, as the fluid is dispensed. Regardless, as the fluid chamber within the cartridge 20 is emptied, the center of balance shifts slightly along the grip, maintaining ease of operation throughout the life of the cartridge 20. As shown in FIG. 13, the handle 26 may be generally aligned with the cartridge 20, or as shown in FIG. 14, an angle may be formed between the handle 26 and the cartridge 20. This angle may be a rigid connection, or may be formed by an articulable joint (not shown) on the sprayer 10 that enables the angle between the cartridge 20 and the handle 26. The joint may comprise a spring-loaded mechanism, friction lock, or other comparable adjusting mechanism. In addition, in a further optional feature of the device, after connection of the cartridge 20 to the handle 26, the cartridge 20 may further be rotated along its longitudinal axis, preferably to pre-set angles from one to forty five degrees, and more preferably approximately fifteen to thirty degrees, as may be desired by the user, by rotating an interface 23 between the cartridge and handle. The rotation may be provided by a joint (not shown) comprising opposing discs having knobs and detents, spring loaded mechanisms, friction locks, or other comparable adjusting mechanism. Regardless of the configuration used, the desired result is improved manipulative control over the sprayer, more even application, and reduced fatigue for the user.

Referring next to FIGS. 11A and 11B in conjunction with FIG. 1, fluid disposed in the fluid chamber of cartridge 20 flows through aperture 25 into the manifold 90 which distributes it to the nozzles 22 (shown presently in an alternate, non-tapered construction). In one embodiment, the manifold 90, includes distribution channels 91. The array of nozzles 22 is typically linear, typically between four and seven inches in length, but may be in other forms.

While certain representative embodiments and details have been shown for purposes of illustrating the invention, it will be apparent to those skilled in the art that various changes may be made without departing from the scope of the invention, which is defined in the appended claims.

1. A fluid dispensing cartridge for use with a spray device, said cartridge comprising:
a fluid chamber comprising a proximal end and a distal end substantially opposite said proximal end;
a lead screw disposed within said fluid chamber and extending substantially between said proximal and distal ends;
a piston defining a bore therein that is threadably cooperative with said lead screw such that upon rotation of said lead screw, said piston advances along said lead screw to pressurize at least a portion of a fluid disposed in said fluid chamber, thereby forcing the pressurized fluid out a discharge aperture formed in said distal end; and
a self-actuating seal disposed between said bore and said lead screw to inhibit fluid leakage therebetween, said seal achieving at least a portion of its self-actuating capability by its distal extension into said fluid chamber such that upon pressure being applied to an outer surface of said distal extension from the pressurized fluid, said seal is compressed such that a tightness of fit between said seal and said screw is increased.

2. The cartridge of claim 1, further comprising an elastomeric sleeve disposed on an outer surface of said seal.

3. The cartridge of claim 1, wherein said seal is integrally formed with said piston.

4. The cartridge of claim 1, wherein said outer surface of said seal is tapered from a first outer diameter at a more proximal end to a second outer diameter at a more distal end, said second outer diameter being smaller than said first outer diameter.

5. The cartridge of claim 1, wherein said threadably cooperative portions of said lead screw and said seal comprise complementary-shaped threads formed in each.

6. The cartridge of claim 1, wherein said seal is made of a material having a hardness at least equal to that of said piston.

7. The cartridge of claim 1, further comprising a frame configured to provide axial and radial support to said lead screw, said frame resiliently connected to said fluid chamber such that same frame inhibits movement of said lead screw toward said proximal end of said cartridge.

8. The cartridge of claim 1, wherein said seal and said piston are rigidly affixed to one another such that neither substantially rotate in response to said rotation of said lead screw.

9. A spray device comprising:
a fluid dispensing cartridge comprising:
a fluid chamber comprising a proximal end and a distal end substantially opposite said proximal end;
a lead screw disposed within said fluid chamber;
a piston defining a bore therein, said bore cooperative with said lead screw such that upon rotation of said lead screw, said piston advances toward said distal end to pressurize a fluid contained in said cartridge; and
a self-actuating seal disposed between said bore and said lead screw to inhibit fluid leakage therebetween, said seal achieving at least a portion of its self-actuating capability by its distal extension into said fluid chamber such that upon pressure being applied to an outer surface of said distal extension from the pressurized fluid, said seal is compressed such that a tightness of fit between said seal and said screw is increased;
at least one discharge nozzle in fluid communication with said fluid chamber; and
a handle configured to attachably receive said cartridge, said handle comprising:
a power source configured to impart pressure to the fluid disposed in said fluid chamber through cooperation with said lead screw;
a high voltage electrical source configured to impart an electric charge to at least one of the fluid and said at least one discharge nozzle; and
a switch to selectively turn said spray device on and off.

10. The spray device of claim 9, wherein said spray device is an electrohydrodynamic spray device.

11. The spray device of claim 10, further comprising a spray manifold in fluid communication with said cartridge, and wherein said at least one discharge nozzle comprises a plurality of nozzles in fluid communication with said spray manifold, at least one of said manifold and said plurality of nozzles electrically coupled with said high voltage electrical source such that upon operation of said spray device, a voltage is applied to said at least one of said manifold and said plurality of nozzles such that at least a portion of said fluid being discharged from said plurality of nozzles is comminuted.

12. The spray device of claim 9, wherein said spray device is an electrostatic spray device.

13. The spray device of claim 9, further comprising a closure valve fluidly disposed between said fluid chamber and said at least one discharge nozzle.

14. The spray device of claim 9, wherein said cartridge is a non-reusable cartridge in that prior to being received by said handle, said fluid chamber includes the fluid therein such that the fluid is substantially isolated from the ambient environment, and upon receipt of said cartridge into said handle, a permanent aperture is formed in said cartridge.

15. The spray device of claim 14, wherein said cartridge is rigidly affixed to at least one of said spray manifold and said plurality of nozzles such that once the fluid contained in said fluid chamber is dispensed, said cartridge, said spray manifold and said nozzles form a disposable assembly.

16. A method of operating a spray device, said method comprising:
disposing a fluid within a cartridge, said cartridge comprising:
a fluid chamber comprising a proximal end and a distal end substantially opposite said proximal end;
a lead screw disposed within said fluid chamber and extending substantially between said proximal and distal ends;
a piston threadably cooperative with said lead screw; and
a self-actuating seal disposed between said piston and said lead screw;
connecting said cartridge to a handle;
providing power to said cartridge through said handle so that said lead screw advances said piston to pressurize said fluid and force it out of said cartridge through a fluid passageway formed in said cartridge; and
inhibiting fluid leakage between said seal and said piston by having said seal distally extend into said fluid chamber from said piston such that said pressurized fluid applies pressure to an outer surface of said seal such that said application of pressure compresses said seal an amount necessary to increase fit tightness between said seal and said screw.

17. The method of claim 16, wherein said seal and said piston are integrally formed.

18. The method of claim 16, wherein said seal comprises a material that is at least as hard as a material making up said piston.

19. The method of claim 16, further comprising placing an elastomeric sleeve on said seal.

20. The method of claim 16, wherein said spray device comprises an electrohydrodynamic spray device such that said handle further comprises:
a rotational power source and a high voltage electrical power source;
a switch configured to control delivery of power from said rotational power source to said cartridge;
a spray manifold configured to be in fluid communication with said cartridge; and
a plurality of nozzles in fluid communication with said spray manifold, at least one of said manifold and said plurality of nozzles in electrical communication with said high voltage electrical power source such that upon application of a voltage to said at least one of said manifold and said plurality of nozzles, at least a portion of said fluid being discharged from said plurality of nozzles is comminuted during said method.
